(19) United States
(12) Patent Application Publication
(10) Pub. No.: US 2011/0081182 A1
(43) Pub. Date: Apr. 7, 2011

(54) IMAGE FORMING APPARATUS

(76) Inventor: Toshiki TAKIGUCHI, Osaka (JP)

(21) Appl. No.: 12/895,961

(22) Filed: Oct. 1, 2010

(30) Foreign Application Priority Data
Oct. 2, 2009 (JP) 2009-230359

(51) Int. Cl. G03G 15/00

(52) U.S. Cl. 399/400

(57) ABSTRACT

An image forming apparatus according to the present invention comprises a cylindrical photosensitive body, a transfer unit, a fixing unit and a paper guide. The photosensitive body carries an image on it. The transfer unit includes a transfer roller in compressive contact with the photosensitive body. The fixing unit includes a heating roller and a pressing roller. The paper guide is positioned between the transfer and fixing units. The photosensitive body and the transfer roller are so arranged that the nip tangent between this body and this roller inclines toward the paper guide away from a line connecting the nip between this body and this roller and the nip between the heating and pressing rollers. The paper guide has a recess formed nearer the nip between the is photosensitive body and the transfer roller than the midpoint on the line connecting the two nips.

### CROSS REFERENCE

This Nonprovisional application claims priority under 35 U.S.C. §119(a) on Patent Application No. 2009-230359 filed in Japan on Oct. 2, 2009, the entire contents of which are hereby incorporated by reference.

### BACKGROUND OF THE INVENTION

The present invention relates to an image forming apparatus that transfers toner to and fix it on paper.

A printing process has been used with an electrophotographic image forming apparatus. The apparatus includes a cylindrical photosensitive body, a transfer unit, and a fixing unit. The process includes transferring the toner on the photosensitive body to a sheet of paper by means of the transfer unit and subsequently fixing the toner on the sheet by means of the fixing unit.

If the nip pressure between the photosensitive body and the transfer roller of the transfer unit is high, the pressure may crush the toner on the photosensitive body. The crushed toner agglomerates, so that the toner image transferred to the sheet may have portions without toner.

JP-1990-262175-A discloses an invention for making a peripheral speed difference between a photosensitive body and a transfer roller so as to prevent toner agglomeration, preventing a transferred toner image from having portions without toner.

The invention disclosed by JP-1990-262175-A may be embodied by an image forming apparatus including a cylindrical photosensitive body, a transfer roller, and a fixing unit. If the nip pressure between the photosensitive body and the transfer roller is too high, it is still impossible to completely prevent a transferred toner image from having portions without toner. Therefore, it is preferable that the nip pressure be as low as possible. The fixing unit includes a heating roller and a pressing roller. The nip pressure between the heating and pressing rollers is considerably higher than the nip pressure between the photosensitive body and the transfer roller so that toner can be fixed on a sheet of paper.

Accordingly, if the speed at which the photosensitive body and the transfer roller are conveying a sheet of paper is lower than the speed at which the heating and pressing rollers are conveying the sheet, the heating and pressing rollers pull the sheet downstream, so that the scaling ratio of the image transferred to the sheet is higher in the direction in which the sheet is conveyed. The higher scaling ratio lowers the quality of the image.

Therefore, there is a general tendency for the photosensitive body and transfer roller of an image forming apparatus to convey a sheet of paper at a higher speed than the heating and pressing rollers of the apparatus. In this case, while the sheet is conveyed, it bends, creating reaction force of conveyance, which is exerted on the nip between the heating and pressing rollers and the nip between the photosensitive body and the transfer roller at the same time. Because the nip pressure between the photosensitive body and the transfer roller is lower than the nip pressure between the heating and pressing rollers, the reaction force of conveyance more greatly affects the nip pressure between the photosensitive body and the transfer roller. The behavior of the sheet being conveyed between the two nips makes the reaction force of conveyance different widthwise of the sheet (perpendicularly to the conveying direction). Accordingly, the speed at which the sheet is conveyed through the nip between the photosensitive body and the transfer roller may be different widthwise of the sheet, so that the image on the sheet may be oblique at an end portion of the sheet.

In view of the foregoing problems, the object of the present invention is to provide an image forming apparatus that weakens the reaction force of conveyance of a sheet of paper at the nip between the photosensitive body and transfer roller of the apparatus so as to prevent the speed at which the sheet is conveyed through the nip from being unbalanced widthwise of the sheet.

### SUMMARY OF THE INVENTION

An image forming apparatus according to the present invention comprises a cylindrical photosensitive body, a transfer unit, a fixing unit and a paper guide. The photosensitive body carries an image on it. The transfer unit includes a transfer roller in compressive contact with the photosensitive body. The fixing unit includes a heating roller and a pressing roller, which are in compressive contact with each other. The paper guide is positioned between the transfer and fixing units. The photosensitive body and the transfer roller are so arranged that the nip tangent between this body and this roller inclines toward the paper guide away from a line connecting the nip between this body and this roller and the nip between the heating and pressing rollers. The paper guide has a recess formed nearer the nip between the photosensitive body and the transfer roller than the midpoint on the line connecting the two nips.

The sheet of paper nipped between the photosensitive body and the transfer roller and between the heating and pressing rollers bends toward the paper guide. The apex of the bend comes to the recess. Accordingly, the bend apex is nearer to the nip between the photosensitive body and the transfer roller than the midpoint on the line connecting the two nips. This makes the reaction force of conveyance of the sheet less liable to be exerted on the nip between the photosensitive body and the transfer roller, so that it is possible to prevent the speed at which the sheet is conveyed through this nip from being unbalanced widthwise of the sheet.

### BRIEF DESCRIPTION OF THE DRAWINGS

FIG. 1 is a drawing showing the structure of an image forming apparatus according to a first embodiment of the present invention.

FIG. 2 is a schematic diagram showing the arrangement of the paper guide of the image forming apparatus and parts around the guide.

FIG. 3 is a schematic diagram showing the paper guide and the parts around it.

FIG. 4 is a schematic diagram showing the paper guide of an image forming apparatus according to a second embodiment of the present invention and parts around this guide.

FIG. 5 is a schematic diagram showing the paper guide of an image forming apparatus according to a third embodiment of the present invention and parts around this guide.

FIG. 6 is a schematic diagram showing the paper guide of an image forming apparatus according to a fourth embodiment of the present invention and parts around this guide.

### DETAILED DESCRIPTION OF THE INVENTION

Image forming apparatus embodying the present invention will be described in detail below with reference to the drawings.

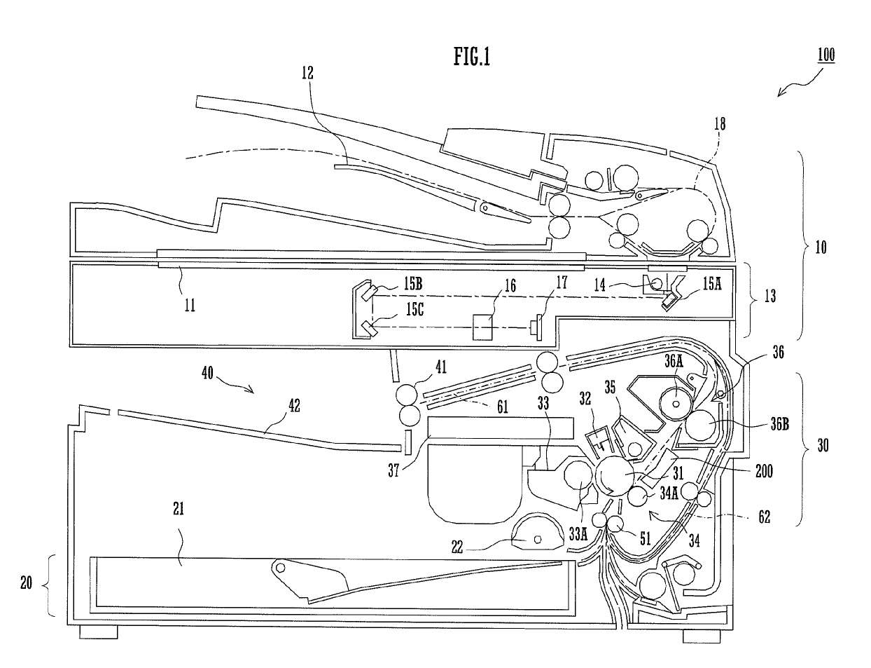

FIG. 1 is a drawing showing the structure of an image forming apparatus 100 according to a first embodiment of the present invention.

The image forming apparatus 100 forms an image on a sheet of paper in one of image forming modes, which are a copier mode, a printer mode, and a fax mode. One of the modes can be selected by a user. The image forming apparatus 100 can do double-side printing.

The image forming apparatus 100 includes a document reading section 10, a paper feeding section 20, an image forming section 30, a delivery section 40, and an operation panel (not shown). The document reading section 10 is positioned at the top of the apparatus 100 and includes platen glass 11, a document tray 12, and a scanner optical system 13. The optical system 13 includes a light source 14, reflecting mirrors 15A-15C, an optical lens 16, and a CCD (charge coupled device) 17. The light source 14 radiates light to the document placed on the platen glass 11 or the document being conveyed along a document path 18 from the document tray 12. The reflecting mirrors 15A-15C reflect the light reflected from the document and direct the light at the optical lens 16. The optical lens 16 images on the CCD 17 the reflected light directed by the reflecting mirrors 15A-15C. The CCD 17 outputs an electric signal according to the reflected light.

The paper feeding section 20 is positioned at the bottom of the image forming apparatus 100 and includes a feed tray 21 and a pickup roller 22. The feed tray 21 holds sheets of paper. Rotation of the pickup roller 22 feeds the held sheets to a paper path 61, where images can be formed on them.

The image forming section 30 is positioned under the document reading section 10 and adjacent to a hand feed tray. The image forming section 30 includes a laser scanning unit (hereinafter referred to as “LSU”) 37, a photosensitive drum 31, and a fixing unit 36. The photosensitive drum 31 is surrounded by a charging unit 32, a developing unit 33, a transfer unit 34, and a cleaner unit 35 in that order in the direction (indicated by an arrow in FIG. 1) in which the drum 31 rotates.

Register rollers 51 are supported on the paper path 61. If the start key on the operation panel is pressed, the pickup roller 22 rotates to feed a sheet of paper to the paper path 61 and convey it to the register rollers 51.

The register rollers 51 are stopping when the front end of the sheet reaches them. Rotation of the register rollers 51 is so timed to start that the front ends of the sheet and the toner image formed on the photosensitive drum 31 register with each other at the nip between the drum and the transfer unit 34.

A paper guide 200 is positioned between the photosensitive drum 31 and fixing unit 36, and between the transfer unit 34 and fixing unit 36. The paper guide 200 enables the sheet to be conveyed smoothly from the nip between the photosensitive drum 31 and transfer unit 34 to the fixing unit 36.

The charging unit 32 charges the cylindrical surface of the photosensitive drum 31 uniformly to a specified electric potential. The charging unit 32 is a charger as shown in FIG. 1 but might be a contact type charger such as a roller type or brush type charger.

The LSU 37 exposes the charged surface of the photosensitive drum 31 to light according to the image data input to the LSU. The exposure forms on the drum surface an electrostatic latent image according to the image data. The LSU 37 includes a laser beam emitter and a reflecting mirror. The LSU 37 also includes a polygon mirror that reflects a laser beam to scan the drum surface. The LSU 37 further includes optical elements such as a lens and a mirror that lead the reflected beam to the photosensitive drum 31. Alternatively, the LSU 37 might be an EL or LED write head, which includes an array of light emitting devices.

The developing unit 33 includes an MG roller 33A and develops the electrostatic latent image on the photosensitive drum 31 with toner, which sticks to the cylindrical surface of the roller 33A. The cylindrical surface of the photosensitive drum 31 attracts the sticking toner according to the potential gaps on the drum surface. The attracted toner sticks to the drum surface, so that the electrostatic latent image is developed into a toner image.

The transfer unit 34 includes a transfer roller 34A. The cylindrical surfaces of the transfer roller 34A and photosensitive drum 31 are in compressive contact with each other with a specified nip between them. A high voltage is applied to the transfer roller 34A so that the toner on the photosensitive drum 31 can be transferred to the sheet passing through the nip. The voltage is positive, and the toner is negatively charged.

The cleaner unit 35 removes and recovers the toner remaining on the photosensitive drum 31 after the image development and transfer.

The fixing unit 36 includes a heating roller 36A and a pressing roller 36B, which rotate with the sheet nipped between these rollers. A controller (not shown) makes the heating roller 36A have a specified fixing temperature in accordance with the signal from a temperature sensor (not shown). The heating roller 36A cooperates with the pressing roller 36B to thermocompressively bond the transferred toner to the sheet. The thermocompressive bonding melts, mixes, and presses the transferred toner image on the sheet, thereby thermally fixing the image to the sheet.

The delivery section 40 is positioned over the feed tray 21 and includes reversible delivery rollers 41 and a delivery tray 42. Normal rotation of the delivery rollers 41 delivers to the delivery tray 42 the sheet conveyed along the paper path 61. The image forming apparatus 100 can perform double-side image formation by first forming an image on one side of the sheet, then conveying the sheet along the paper path 61, nipping the conveyed sheet between the delivery rollers 41 rotating in the normal directions, subsequently reversing these rollers so as to convey the nipped sheet to a paper path 62, and bringing the other side of the sheet into contact with the cylindrical surface of the photosensitive drum 31, where another toner image can be transferred to this side of the sheet. The delivery tray holds in a pile the sheets delivered from the delivery rollers 41.

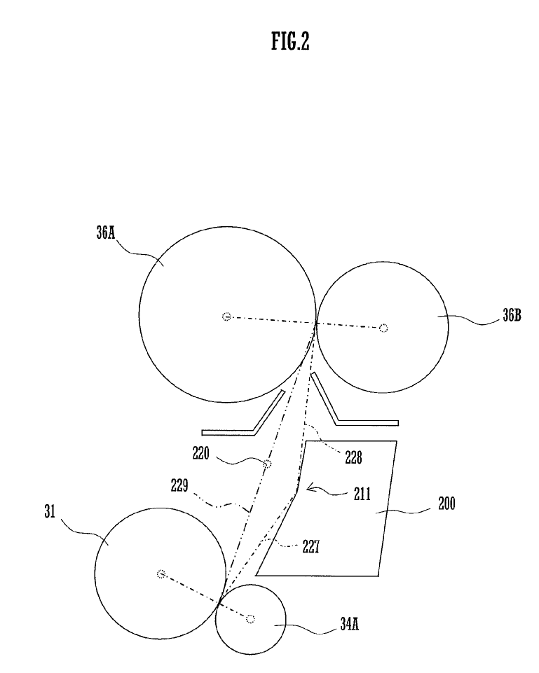

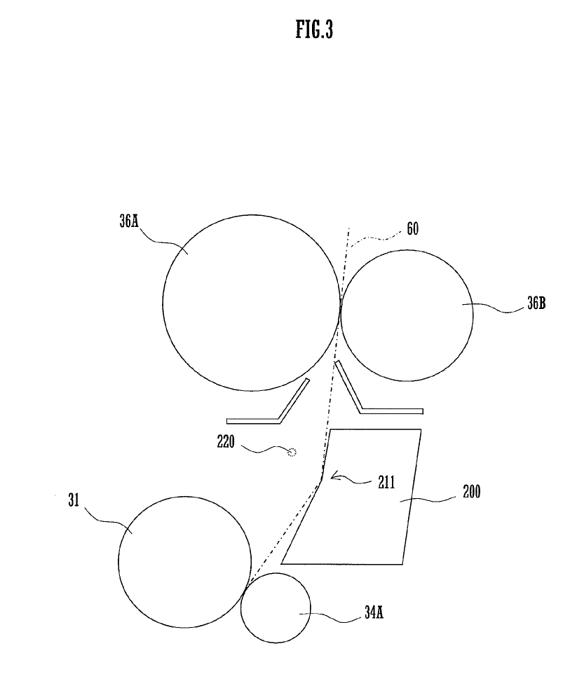

FIG. 2 is a schematic diagram showing the arrangement of the paper guide 200 and parts around it. FIG. 3 is a schematic diagram showing the paper guide 200 and the parts around it.

The image forming apparatus 100 conveys a sheet of paper at a higher speed at the nip between the photosensitive drum 31 and transfer roller 34A than at the nip between the heating roller 36A and pressing roller 36B. The speed difference prevents the fixing unit 36 from pulling downstream the sheet nipped between the photosensitive drum 31 and transfer roller 34A. This prevents the scaling ratio of the image transferred to the sheet from increasing and consequently keeps the quality of the transferred image from declining.

FIG. 3 shows a sheet of paper 60 being conveyed from the nip between the photosensitive drum 31 and transfer roller 34A to the nip between the heating roller 36A and pressing roller 36B. As shown in FIG. 2, the two nips are connected with a line 229.

The photosensitive drum 31 and transfer roller 34A are so arranged that the nip tangent 227 between the drum and this roller inclines away from the line 229 between the nips toward the paper guide 200. As a result, a middle portion of the sheet 60 bends toward the paper guide 200.

The paper guide 200 has a recess 211 formed nearer the nip between the photosensitive drum 31 and transfer roller 34A than the midpoint 220 on the line 229 between the two nips. It is preferable that, as shown in FIG. 2, the recess 211 be positioned at the intersection point where the nip tangent 227 between the photosensitive drum 31 and transfer roller 34A meets the nip tangent 228 between the heating roller 36A and pressing roller 36B. If the recess 211 is positioned at the intersection point, the apex of the bend of the sheet 60 is liable to come to the recess 211. If the bend apex comes to the recess 211, the apex is nearer to the nip between the photosensitive drum 31 and transfer roller 34A than the midpoint 220.

This makes the reaction force of conveyance of the sheet 60 less liable to be exerted on the nip between the photosensitive drum 31 and transfer roller 34A. Consequently, it is possible to prevent the speed at which the sheet 60 is conveyed through this nip from being unbalanced widthwise of the sheet. As a result, it is possible to prevent the image on the sheet 60 from shifting or shearing obliquely at a rear end portion of the sheet.

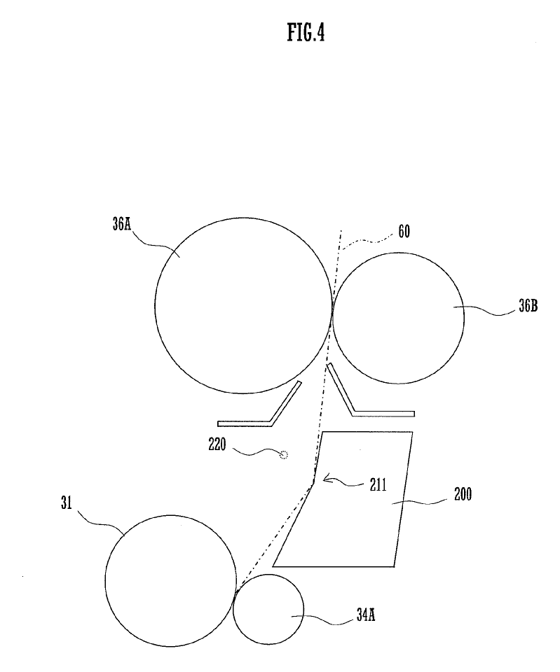

FIG. 4 is a schematic diagram showing the paper guide 200 of an image forming apparatus according to a second embodiment of the present invention and parts around this guide.

The photosensitive drum 31 and transfer roller 34A of this apparatus are so arranged that the nip tangent between the drum and the roller inclines away from the line connecting the nip between the drum and the roller and the recess 211 of the paper guide 200 toward the line connecting this nip and the nip between the heating roller 36A and pressing roller 36B of the apparatus. The inclination makes a sheet of paper 60 enter the nip between the photosensitive drum 31 and transfer roller 34A at a larger angle with the nip tangent between the drum and this roller than in the first embodiment.

This makes the sheet 60 liable to bend relative to the nip between the photosensitive drum 31 and transfer roller 34A, so that the reaction force of conveyance of the sheet 60 is less liable to be exerted on this nip. Consequently, it is possible to prevent the speed at which the sheet 60 is conveyed through this nip from being unbalanced widthwise of the sheet. As a result, it is possible to prevent the image on the sheet 60 from shifting or shearing obliquely at a rear end portion of the sheet.

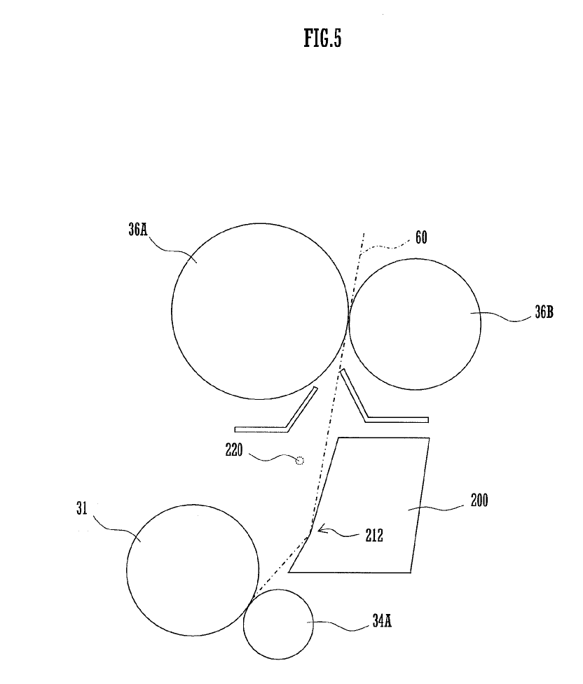

FIG. 5 is a schematic diagram showing the paper guide 200 of an image forming apparatus according to a third embodiment of the present invention and parts around this guide.

This paper guide 200 has a recess 212 formed near the quarter point on a line extending from the nip between the photosensitive drum 31 and transfer roller 34A of this apparatus to the nip between the heating roller 36A and pressing roller 36B of the apparatus. It is essential that the recess 212 be positioned nearer the nip between the photosensitive drum 31 and transfer roller 34A than the midpoint 220 on the line between the two nips. It is preferable that the recess 212 be positioned between the midpoint 220 and the fifth-part point on the line between the nips. If the recess 212 is so positioned, it is possible to prevent the speed at which a sheet of paper 60 is conveyed through the nip between the photosensitive drum 31 and transfer roller 34A from being unbalanced widthwise of the sheet. This makes it possible to prevent the image on the sheet 60 from shifting or shearing obliquely at a rear end portion of the sheet.

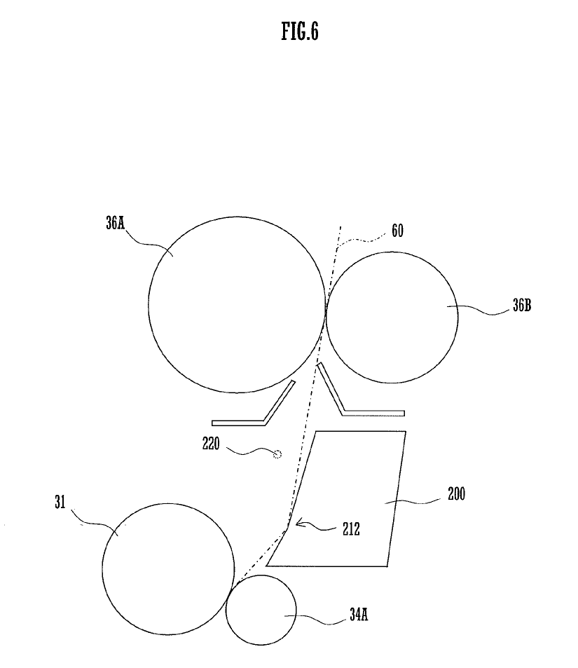

FIG. 6 is a schematic diagram showing the paper guide 200 of an image forming apparatus according to a fourth embodiment of the present invention and parts around this guide.

This embodiment is a structural combination of the second and third embodiments. If the structural requirements of the embodiments are met, it is possible to form a recess in an arbitrary position in this paper guide 200 and arrange the photosensitive drum 31 and transfer roller 34A of this apparatus in an arbitrary position. The structural combination of the embodiments as well makes it possible to prevent the speed at which a sheet of paper 60 is conveyed through the nip between the photosensitive drum 31 and transfer roller 34A from being unbalanced widthwise of the sheet. This makes it possible to prevent the image on the sheet 60 from shifting or shearing obliquely at a rear end portion of the sheet.

The structure of any of the four embodiments enables the image forming apparatus 100 to prevent the speed at which a sheet of paper 60 is conveyed through the nip between the photosensitive drum 31 and transfer roller 34A from being unbalanced widthwise of the sheet. This makes it possible to lower the nip pressure between the photosensitive drum 31 and transfer roller 34A. Consequently, it is possible to prevent toner agglomeration, which might be caused by the nip pressure. The prevention makes it possible to reduce the possibility that the transferred image may have portions without toner.

The structure of any of the four embodiments may make a peripheral speed difference between the photosensitive drum 31 and transfer roller 34A. The peripheral speed difference creates friction between the photosensitive drum 31 and transfer roller 34A. Even if the nip pressure between the photosensitive drum 31 and transfer roller 34A agglomerates the toner, the agglomerated toner can be loosened by the friction. This makes it possible to reduce the possibility that the toner agglomerated by the nip pressure may make the transferred image have portions without toner.

The structure of any of the four embodiments avoids the need to limit the kind of toner for use with the image forming apparatus 100. Because the toner agglomeration can be prevented as stated already, it is possible to use a kind of toner liable to be agglomerated by the nip pressure between the photosensitive drum 31 and transfer roller 34A.

The present invention being thus described, it will be obvious that the invention may be varied in many ways. Such variations are not to be regarded as a departure from the spirit and scope of the invention, and all such modifications as would be obvious to one skilled in the art are intended to be included within the scope of the following claims.

What is claimed is:

1. An image forming apparatus comprising:
a cylindrical photosensitive body for carrying an image thereon;
a transfer unit including a transfer roller in compressive contact with the photosensitive body;
a fixing unit including a heating roller and a pressing roller, the heating and pressing rollers being in compressive contact with each other; and
a paper guide positioned between the transfer and fixing units;
the photosensitive body and the transfer roller being so arranged that the nip tangent between the photosensitive body and the transfer roller inclines toward the paper guide away from a line connecting the nip between the photosensitive body and the transfer roller and the nip between the heating and pressing rollers;
the paper guide having a recess formed nearer the nip between the photosensitive body and the transfer roller than the midpoint on the line connecting the two nips.

2. An image forming apparatus as claimed in claim 1, wherein the photosensitive body and the transfer roller are so arranged that the nip tangent between the photosensitive body and the transfer roller inclines toward the connecting line away from a line connecting the recess and the nip between the photosensitive body and the transfer roller.
